(19) United States
(12) Patent Application Publication
(10) Pub. No.: US 2003/0084332 A1
(43) Pub. Date: May 1, 2003

(54) Method for binding a software data domain to specific hardware

(75) Inventors: Raymond Krasinski, Suffern, NY (US); Martin C. Rosner, Cortlandt Manor, NY (US)

Correspondence Address: Corporate Patent Counsel, U.S Philips Corporation, 580 White Plains Road, Tarrytown, NY, 10591, US

(73) Assignee: KONINKLIJKE PHILIPS ELECTRONICS N.V.

(21) Appl. No.: 10/043,388

(22) Filed: Oct. 26, 2001

(51) Int. Cl. G06F 11/30; G06F 12/14

(52) U.S. Cl. 713/200

(57) ABSTRACT

A copy protection program for securely holding digital audio and/or video content is bound to a particular device via a key derived in part from unique or distinctive hardware, software and/or firmware identifiers within the device and in part from a random or pseudo-random number. The key is checked or rebuilt whenever the copy protection program is employed to access protected digital content, either authorizing/prohibiting such access to the content or enabling/precluding proper decoding of the content. Therefore the digital content need not be directly bound to the device while circumvention of the copy protection is frustrated.

### TECHNICAL FIELD OF THE INVENTION

The present invention is directed, in general, to protection of software and/or data against improper copying and, more specifically, to binding a software or data protection mechanism to specific hardware utilizing an encryption key based at least in part on unique numbers for hardware components.

### BACKGROUND OF THE INVENTION

The Secure Digital Music Initiative (SDMI) digital music standard promulgated at www.sdmi.org defines a “domain,” as an environment within with defined usage rules and behaviors intended to prevent unauthorized copying of digital music are obeyed. The domain includes an application layer, licensed compliant modules (LCMs), portable devices (PDs), portable media (PMs), etc.

Presently no method is specified for binding a software SDMI domain to the hardware on which the domain is legally installed. The protection against improper copying afforded by the SDMI standard might therefore be circumvented by a malicious user making a binary copy of the SDMI domain and distributing the copies inappropriately to others.

There is, therefore, a need in the art for a method of binding a SDMI domain to the hardware on which the domain has been legally installed.

### SUMMARY OF THE INVENTION

To address the above-discussed deficiencies of the prior art, it is a primary object of the present invention to provide, for use in a device for storing or playing digital audio and/or video content, a method of binding a copy protection program for securely holding the digital content to a particular device via a key derived in part from unique or distinctive hardware, software and/or firmware identifiers within the device and in part from a random or pseudo-random number. The key is checked or rebuilt whenever the copy protection program is employed to access protected digital content, either authorizing/prohibiting such access to the content or enabling/precluding proper decoding of the content. Therefore the digital content need not be directly bound to the device while circumvention of the copy protection is frustrated.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a data processing system in which application software may be bound to the underlying hardware according to one embodiment of the present invention;

FIG. 2 illustrates a key employed to bind a copy protection program to a particular device according to one embodiment of the present invention; and

FIG. 3 is a high level flowchart for a process of employing a key to bind a copy protection program to a particular device according to one embodiment of the present invention.

### DETAILED DESCRIPTION OF THE INVENTION

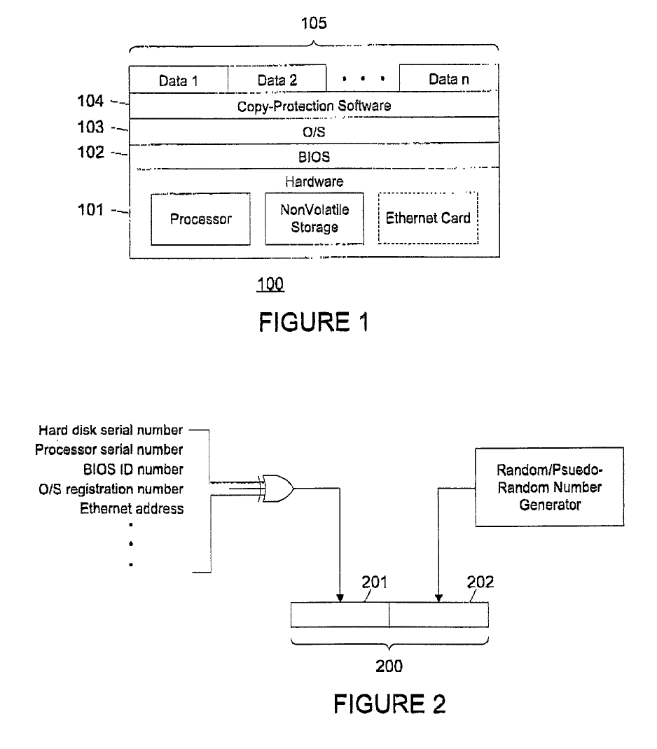

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a data processing system in which application software may be bound to the underlying hardware according to one embodiment of the present invention. Data processing system 100 includes hardware 101 such as a processor, non-volatile storage (e.g., a hard disk drive), and optionally communications facilities such as an Ethernet card. A basic input/output system (BIOS) 102 enables communications with and software control over hardware 101, while an operating system (O/S) 103 permits various specific applications to be executed by hardware 101 through a set of interfaces and user controls.

In the present invention, a copy protection program 104 for holding digital content 105 in a secure manner, protecting digital content 105 by preventing users of an open architecture system (data processing system 100) from making binary copies of the digital content 105 and distributing such copies to others in an unauthorized manner, is employed within data processing system 100. Copy protection program 104 may be, for example, a Secure Digital Music Initiative (SDMI) domain as described above. Alternatively, however, copy protection program 104 may be any program designed to prevent unauthorized copying and distribution of digital audio and/or video content in any of a variety of formats, including but not limited to compact disc audio (CDA), digital versatile disc (DVD), motion picture expert group (MPEG) and motion picture expert group level 3 (MP3), and joint photographic expert group (JPEG) and similar graphic standards. In the present invention, copy protection program 104 is bound to the hardware 101 and software/firmware 102-103 of data processing system 100 in the manner described in further detail below.

While a data processing system 100 is contemplated as a personal computer in the exemplary embodiment, the present invention may be utilized with any of a variety of other devices having similar combinations of hardware, software, and/or firmware for use with digital content. Examples include video receivers, digital audio receivers, and DVD, CDA and/or MP3 players.

FIG. 2 illustrates a key employed to bind a copy protection program to a particular device according to one embodiment of the present invention. The key 200 is employed to bind a program for securely holding digital content (i.e., copy protection program 105 such as an SDMI domain) to the physical hardware, software and/or firmware on which the program is legitimately installed.

Key 200 is formulated from unique or distinctive identifying characteristics of the device on which the copy protection program 105 is installed. For the exemplary embodiment of a personal computer, several unique or distinctive identifiers exists on all systems which may be employed: hard disk serial number; processor serial number; BIOS identifier; operating system registration number; and Ethernet address of network interface card (NIC), if present. Some of the values for these identifiers (for example, the BIOS identifier) are not globally unique on each particular system. However, such distinctive (but not unique) identifiers vary widely enough in use between different devices to provide a sufficient approximation of global uniqueness, particularly when utilized in combination with other sources of unique or distinctive identifiers within the hardware, software, or firmware for the device.

Preferably more than one unique or distinctive identifier from the hardware, software, or firmware is employed in formulating the key 200. In devices other than computers, similar unique identifiers may be found which are accessible or may be made accessible to copy protection program 105 during operation, such as a processor identifier, flash memory identifier, firmware identifier, etc.

Key 200 is formulated from two concatenated portions 201 and 202 when copy protection software 104 is first loaded within device 100. The first portion 201 is assembled by XORing one or more unique or distinctive identifiers from the hardware, software and/or firmware of the device on which the copy protection software 104 is legitimately installed. Preferably multiple identifiers are utilized in formulating the first portion 201, which links the key 200 to the particular device on which copy protection software 104 is installed.

The second portion 202 of key 200 is derived from a random or pseudo-random phenomenon, such as a pseudo-random number generator. This second portion 202 protects the key 200 from attack by trying various permutations of combined hardware, software and/or firmware identifiers, and also contributes to uniqueness of the key 200 where only distinctive (and not globally unique) identifiers from the device are employed for portion 201.

The second portion is concatenated (or otherwise combined) with the first portion 201 to form key 200. Once the key 200 is created, the key is checked to determine whether the value is a known weak key or has characteristics of a known weak key. If the key 200 is believed to be weak, a different value is obtained for the second portion 202 and the key 200 is recomputed, with the process repeating until a non-weak key is produced. The specific steps employed to check for weak keys are dependent upon the encryption algorithm employed, but should be performed regardless of the algorithm selected.

It should be noted that key 200 need not be generated within device 100, but may instead be generated externally during installation of copy protection program 104. The generated key 200, the second portion 202, or both may then be transmitted to the device 100 for storage therein and subsequent use.

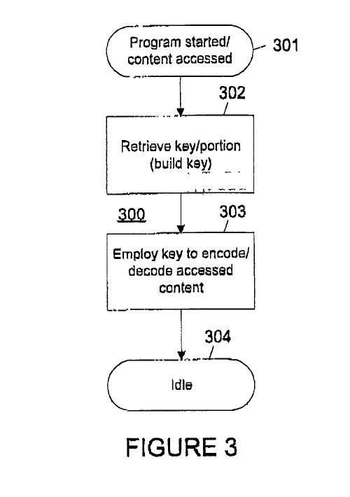

FIG. 3 is a high level flowchart for a process of employing a key to bind a copy protection program to a particular device according to one embodiment of the present invention. The process is performed by copy protection program 104 utilizing key 200. The process 300 begins with the copy protection program 104 being either started or employed to access digital content 105 securely held by copy protection program 104 (step 301). That is, the process 300 may be triggered by the copy protection program 104 being started within device 100 or by each individual use of copy protection program 104 to access digital content 105.

The key 200 and/or the second portion 202 of the key 200 are first retrieved (step 302). Once formulated, key 200 and/or the second portion 202 of the key 200 are stored within a hidden nonvolatile memory area within the device, preferably accessible only to the copy protection program 104. If both the complete key 200 and the second portion 202 are stored within the device 100, the key 200 may optionally be checked by rebuilding the key 200: accessing the specified identifiers employed to create the first portion 201, utilizing the retrieved values to generate the first portion 201 to recreate the key 200, then comparing the result with the stored value.

For added security, however, the complete key 200 may not be stored within device 100, but instead rebuilt whenever required by retrieving specified identifiers from the hardware, software and/or firmware of the device 100 and generating the first portion 201 in a predefined manner. The result is employed to create a value for key 200, and no checking is required.

The key 200 is then employed by copy protection software 104 to either control access to digital content 105 or to directly encode or decode any digital content 105 being accessed via copy protection program 104, either by being retrieved for playback, transmission or copying or by being securely loaded into selected media by copy protection program 104. If the full key 200 is stored within device 100, copy protection program 104 may simply check the key 200 prior to allowing digital content 105 to be encoded or decoded utilizing a separate algorithm and/or key, where such separate encryption/decryption is not permitted by copy protection program 104 if the stored value does not match the value generated utilizing selected hardware, software and/or firmware identifiers from device 100.

Whether or not the full key 200 is stored within device 100, key 200 may also be directly employed in encoding or decoding digital content 105. Such use of key 200 has the effect of binding the particular copies of digital content 105 to the device 100, which may or may not be desirable depending upon whether the user is to be permitted to copy or transfer the digital content 105 onto (for instance) portable media. Alternatively, digital content 105 may be encrypted utilizing key 200 (with or without additional keys), then decrypted and re-encrypted utilizing an independent key when being transferred to portable media and/or a portable device.

Regardless of whether employed directly in encoding and decoding digital content 105 to device 100, key 200 frustrates binary copying of copy protection program 104 to a device other than device 100. If the physical hardware, software and/or firmware differs from that of device 100 on which copy protection program 104 was (legitimately) installed or loaded, the key 200 will no longer match the device characteristics and will fail. Key 200 is rebuilt or checked based upon preselected device identifiers, with copy protection software 104 permitting decoding of digital content 105 if the result matches the stored key or properly decoding digital content 105 if the result matches the key employed to encode digital content 105, and preventing decoding or improperly decoding digital content 105 when the result does not match. The binding of copy protection program 104 to device 100 is therefore independent of the specific encryption algorithm employed to formulate key 200, and may be independent of the encryption algorithm and/or keys employed to encode digital content 105.

The present invention frustrates attempts to circumvent protection of digital content by wholesale copying of copy protection programs. At the same time, some authorized copying of the actual digital content itself (as opposed to the copy protection program) between devices may be permitted, as where the content provider wishes to enable the user to transfer an MP3 from a music library to a portable player and back.

It is important to note that while the present invention has been described in the context of a fully functional device, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system for binding copy protection to a device comprising:
a key derived in part from at least one preselected unique or distinctive hardware, software or firmware identifier within the device and in part from a random or pseudo-random number; and
a copy protection program securely holding protected content which validates the device based upon the key when employed to access the protected content.

2. The system as set forth in claim 1 wherein the copy protection program validates the device by:
accessing a value within the device for the at least one preselected hardware, software or firmware identifier;
retrieving a stored value relating to the key from a storage location within the device;
computing a value for the key from the accessed value for the at least one preselected hardware, software or firmware identifier and the stored value relating to the key; and
at least one of:
controlling access to the protected content based upon a comparison of the computed value for the key and the stored value relating to the key; and
employing the computed value for the key to decrypt the protected content.

3. The system as set forth in claim 2 wherein the key is derived in part from a plurality of preselected unique or distinctive identifiers for hardware, software or firmware within the device.

4. The system as set forth in claim 2 wherein the key is employed to control access to the protected content without being employed to encrypt or decrypt the protected content, thereby allowing the protected content to be copied or transferred from the device to another device.

5. The system as set forth in claim 2 wherein the stored value relating to the key contains only the random or pseudo-random number.

6. A device for storing or playing protected content comprising:
at least one hardware, software or firmware component within the device having associated therewith a unique or distinctive identifier; and
a copy protection program selectively executable within the device and securely holding the protected content, wherein the copy protection program, when employed to access the protected content, validates the device based upon a key derived in part from the identifier for the at least one hardware, software or firmware component and in part from a random or pseudo-random number.

7. The device as set forth in claim 6 wherein the copy protection program validates the device by:
accessing a value within the at least one hardware, software or firmware component for the associated identifier;
retrieving a stored value relating to the key from a storage location within the device;
computing a value for the key from the accessed value for the identifier associated with the at least one hardware, software or firmware component and the stored value relating to the key; and
at least one of:
controlling access to the protected content based upon a comparison of the computed value for the key and the stored value relating to the key; and
employing the computed value for the key to decrypt the protected content.

8. The device as set forth in claim 7 wherein the key is derived in part from each of a plurality of unique or distinctive identifiers for preselected hardware, software or firmware components within the device.

9. The device as set forth in claim 7 wherein the key is employed to control access to the protected content without being employed to encrypt or decrypt the protected content, thereby allowing the protected content to be copied or transferred from the device to another device.

10. The device as set forth in claim 7 wherein the stored value relating to the key contains only the random or pseudo-random number.

11. A method for storing or playing protected content within a device having at least one hardware, software or firmware component with a unique or distinctive identifier associated therewith comprising:
executing a copy protection program within the device which securely holds the protected content, wherein the copy protection program, when employed to access the protected content, validates the device based upon a key derived in part from the identifier for the at least one hardware, software or firmware component and in part from a random or pseudo-random number.

12. The method as set forth in claim 11 wherein the copy protection program validates the device by:
accessing a value within the at least one hardware, software or firmware component for the associated identifier;
retrieving a stored value relating to the key from a storage location within the device;
computing a value for the key from the accessed value for the identifier associated with the at least one hardware, software or firmware component and the stored value relating to the key; and
at least one of:
controlling access to the protected content based upon a comparison of the computed value for the key and the stored value relating to the key; and
employing the computed value for the key to decrypt the protected content.

13. The method as set forth in claim 12 wherein the step of computing a value for the key from the accessed value for the identifier associated with the at least one hardware, software or firmware component and the stored value relating to the key further comprises:
deriving the key in part from each of a plurality of unique or distinctive identifiers for preselected hardware, software or firmware components within the device.

14. The method as set forth in claim 12 wherein the step of controlling access to the protected content based upon a comparison of the computed value for the key and the stored value relating to the key further comprises:
employing the key to control access to the protected content without employing the key to encrypt or decrypt the protected content, thereby allowing the protected content to be copied or transferred from the device to another device.

15. The method as set forth in claim 12 further comprising:
storing only the random or pseudo-random number within the storage location within the device.

16. A software key for binding copy protection to a device and transmitted within a signal to the device comprising:
a first portion derived from at least one preselected unique or distinctive hardware, software or firmware identifier within the device; and
a second portion derived from a random or pseudo-random number,
wherein the key is employed by a copy protection program securely holding protected content within the device to validate the device when employed to access the protected content.

17. The software key as set forth in claim 16 wherein the first portion is derived from each a plurality of preselected unique or distinctive identifiers for hardware, software or firmware within the device.

18. The software key as set forth in claim 16 wherein the key is employed by the copy protection program to control access to the protected content without being employed to encrypt or decrypt the protected content, thereby allowing the protected content to be copied or transferred from the device to another device.

19. The software key as set forth in claim 16 wherein only the random or pseudo-random number is stored within the device.

20. The software key as set forth in claim 16 wherein only the random or pseudo-random number is transmitted within the signal to the device.
